(19) United States
(12) Patent Application Publication
(10) Pub. No.: US 2013/0318274 A1
(43) Pub. Date: Nov. 28, 2013

(54) Scalable Portable-Computer System

(71) Applicant: Radu Oprea, Bothell, WA (US)

(72) Inventor: Radu Oprea, Bothell, WA (US)

(21) Appl. No.: 13/901,555

(22) Filed: May 23, 2013

Related U.S. Application Data
(60) Provisional application No. 61/651,527, filed on May 24, 2012.

(51) Int. Cl. G06F 13/40

(52) U.S. Cl. CPC G06F 13/40
USPC 710/305

(57) ABSTRACT

A scalable portable-computer system is disclosed. A novel portable-computer comprises a cluster connectivity bus, hard-wired to the central and graphics processing units (CPU and GPU, respectively) of said portable computer.

An innovative portable-computer module comprises a top and a bottom interconnection port, preferably oriented in a plane perpendicular to the base surface of the computer. Different embodiments include a laptop computer, an extended laptop computer and a tablet computer. Several optional modules are also disclosed, including a memory-extension and a base module. Use of suitable adapters ensures that all modules have the same width, length and interconnectivity ports location. A plurality of portable computers and optional modules are interconnectedly stacked, thereby forming an on-demand supercomputing cluster, advantageously utilizing all available CPUs and GPUs. Each individual computer acts as a node in the cluster. One machine is assigned the master role, managing the interactions among cluster nodes.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

The recent years have seen an increasing demand for vast computing resources. One reason is the wide proliferation of virtual prototyping tool, for complex engineering systems. The aerospace and automotive industries are prime examples. Ever more frequently, computer simulations replace physical prototypes building. These simulations often involve very large and complex mathematical models.

Other areas requiring very high computing power are virtual reality applications, experimental physics and various studies of complex phenomena, such as turbulence, or the weather.

The machines that meet such high performance requirements are broadly referred to as “supercomputers”. Supercomputer architecture has changed, from single mainframe-type machines (e.g. early Cray machines) to clusters of smaller, but still dedicated machines, usually called nodes. These nodes intercommunicate by means of Ethernet connections. Even when the individual nodes are built on Personal Computer (PC) architecture, once the cluster is configured, the nodes tend to become permanent fixtures, only utilized within the cluster. Most often, to participate in a cluster, the node computers must be special builds, and would not be readily capable of carrying common PC tasks.

Accordingly, the main objective of the device of this invention is to provide a novel high-performance computing solution, utilizing a temporary configuration, thus effectively making supercomputing-on-demand a reality.

### BRIEF SUMMARY OF THE INVENTION

The solution of the invention herein disclosed overcomes the aforementioned disadvantages of the existing art by utilizing a novel interconnecting approach and device thereof:

A distinctively novel aspect of the device of the invention is the addition of a cluster connectivity bus, available for external interconnectivity. Said cluster connectivity bus is hard-wired to at least the main and graphics processors of the computer, eliminating the need to interpose an Ethernet, USB, or any other type of indirect connection.

As will be clearly explained in the Description and Operation sections of this application, a portable computer, of shape and functionality well-known in the art, is provided with a novel interconnecting device, including an set of preferably two electrical connectors, oriented along a direction substantially perpendicular to the base plane of said portable computer.

In the preferred embodiment of the invention, schematically illustrated by FIG. 1a and FIG. 1b, the portable computer is a folding-display machine, commonly referred to as a notebook, or laptop, PC. A top interconnection port is situated on the top surface of the computer and a bottom interconnection port is located on the base surface of the computer.

Other embodiments include a single-piece, or tablet, computer, along with some optional ancillary modules.

Thus, rather than relying on Ethernet connectivity, the system of the invention hard-wires the central and graphics processors of a computer, to an external interface, thereby affording a rapid and convenient means to create a supercomputing cluster.

### OBJECTS AND ADVANTAGES

Accordingly, several objects and advantages of my invention are:

The main object of the invention is to provide an economically attractive solution for a preferably temporary high-performance computer cluster, utilizing portable computers equipped with a novel interconnectivity device.

A notable advantage of the configuration of the invention is the use of generic portable computers, each machine preserving all of its stand-alone functions. That makes it possible, and indeed very easy, to build on-demand clusters, whereby a number of generic portable computers are interconnected into a high-performance cluster, for a specific task.

Another advantage is the possibility to supplement total cluster memory, by adding more memory modules, as required by a particular job.

An attractive corollary is the potential for financial savings, with businesses where supercomputing applications occur only occasionally. When the need arises, a cluster may be rapidly assembled from borrowed portable computers. The more expensive modules could also be leased.

Once the task has been completed, the participating machines are returned to their individual users and usage. A cluster computing job might be completed over the week-end, without interrupting the daily usage of each individual computer, and without requiring a substantial investment in a dedicated supercomputer.

### BRIEF DESCRIPTION OF THE SEVERAL VIEWS OF THE DRAWING

FIG. 1a is a perspective rendering of a preferred embodiment of the invention, revealing the arrangement of the principal components of the device of the invention, including the top interconnection port.

FIG. 1b is another perspective rendering of the preferred embodiment of FIG. 1a revealing the bottom interconnection port.

FIG. 2a and FIG. 2b are perspective renderings of an alternative embodiment of the invention, revealing the arrangement of the principal components of said alternative embodiment of the invention, including the lateral extension module.

FIG. 3a is an exploded view of yet another alternative embodiment, comprising a tablet computer.

FIG. 3b is a perspective view of the device of FIG. 3a, showing underside details.

FIG. 4a shows the special memory extension module, and its top interconnection port.

FIG. 4b shows the special memory extension module, and its bottom interconnection port.

FIG. 5 shows the innovative base module, including its top and side interconnection ports.

FIG. 6 is an exploded view of an example clustered system, including a base module, a special memory module, a preferred embodiment portable PC and the two alternative embodiments, introduced in FIG. 2 and FIG. 3. In this example, the topmost machine is the master node of the cluster.

FIG. 7 is a similarly exploded view of the system of FIG. 6, viewed from a different angle, showing the bottom interconnection ports of the individual modules, as well as the interconnection adapters.

FIG. 8a is a perspective view of a clustered system, wherein the PC on top of the stack is the master machine of the system.

FIG. 8b is a frontal view of the cluster from FIG. 8a.

FIG. 9 is a perspective view of yet another cluster configuration, wherein the master PC is connected to the lateral interconnection port of the cluster base module.

### LIST OF REFERENCE LETTERS AND NUMERALS

10 Integrated-expansion Portable PC
10a Extended Housing
11 Scalable Mobile PC
11a Extendable Housing
20 Display
30 Top Interconnection Port
40 Bottom Interconnection Port
50 Spacer Means
60 Lateral Extension Module
60a Lateral Port
60b Mating Lateral Port
70 Tablet PC Module
70a Tablet Computer
70b Cluster Adapter
80 Tablet PC Port
90 Memory Module
100 Base Module
105 Side Interconnection Port
110 Interconnection Adapter
120 Connection Cable
A Cluster Stack
B Master Computer

### DETAILED DESCRIPTION OF THE INVENTION

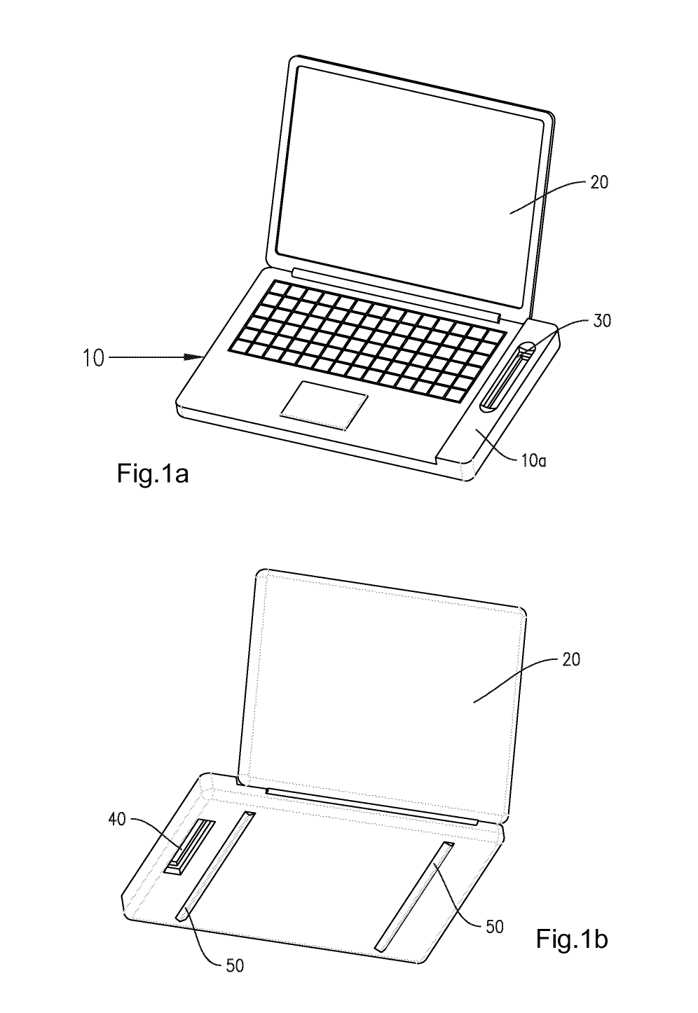

FIG. 1a and FIG. 1b show the principal parts of the preferred embodiment of the novel scalable portable-computer. Components which are well-know in the art, or are not strictly required to explain the functionality of the device, have been removed, or just not numbered, for clarity.

An integrated-expansion portable PC 10 comprises an extended housing 10a and a pivotably-mounted display 20. The housing width substantially exceeds the width of the display. Extended housing 10a comprises a top interconnection port 30 and a preferably identical bottom interconnection port 40. Both interconnection ports are oriented along a plane substantially perpendicular to the base plane of the housing. Thus, the ports are accessible for connection, whether the display is in an open, or closed position.

A distinctively novel aspect of the device of the invention is the presence of a cluster connectivity bus. Said cluster connectivity bus is hard-wired to at least the Central Processing Unit (thereinafter referred to as CPU), to the Graphics Processing Units (GPU in the remainder of this text) of the computer, and to the two aforementioned interconnection ports.

Extended housing 10a may further comprise a plurality of spacer means 50, rigidly mounted on the underside of said extended housing.

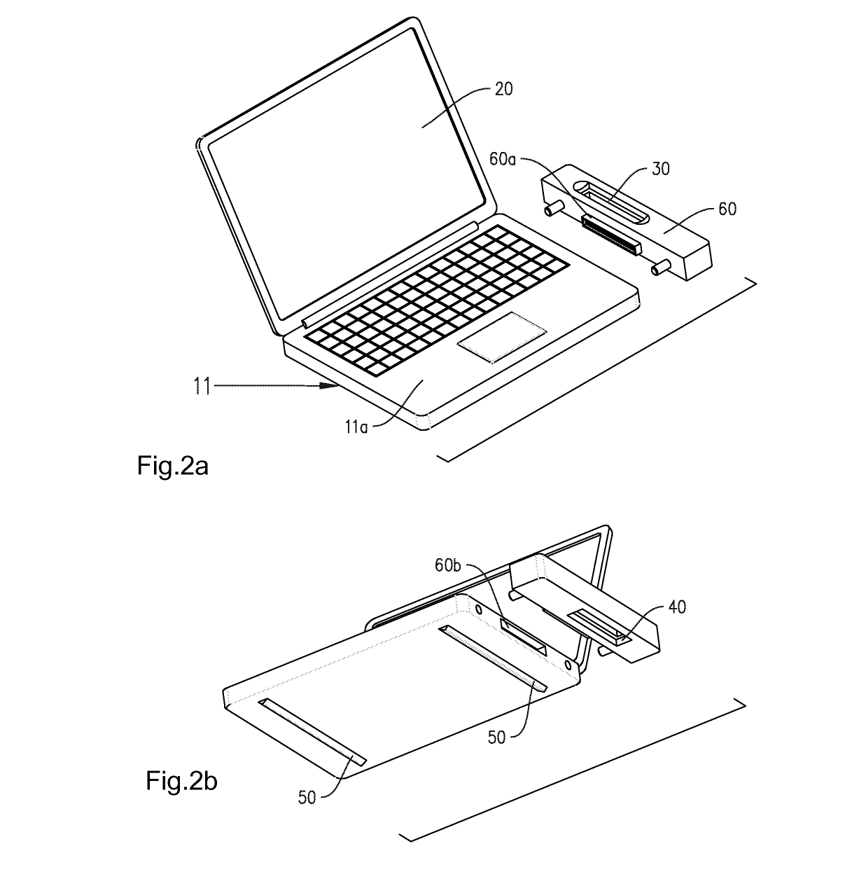

FIG. 2a and FIG. 2b illustrate an alternative embodiment of the portable computer of the invention. Similarly to the preferred embodiment from FIG. 1, a scalable mobile PC 11 comprises an extendable housing 11a and a pivotably-mounted display 20. In this embodiment, however, the width of extendable housing 11a is substantially equal to the width of display 20.

A lateral extension module 60 can be temporarily attached to extendable housing 11. The extension module comprises a top interconnection port 30 and a bottom interconnection port 40, identical to, and in the same spatial arrangement as, the corresponding ports in FIG. 1. Additionally, lateral extension module 60 comprises a lateral port 60a, which connects to mating lateral port 60b, in the housing. The combined width of extendable housing 11a and mounted lateral extension module 60 is substantially equal to the width of extended housing 10a, in FIG. 1.

Extendable housing 11a may further comprise a plurality of spacer means 50, rigidly mounted on the underside of said housing.

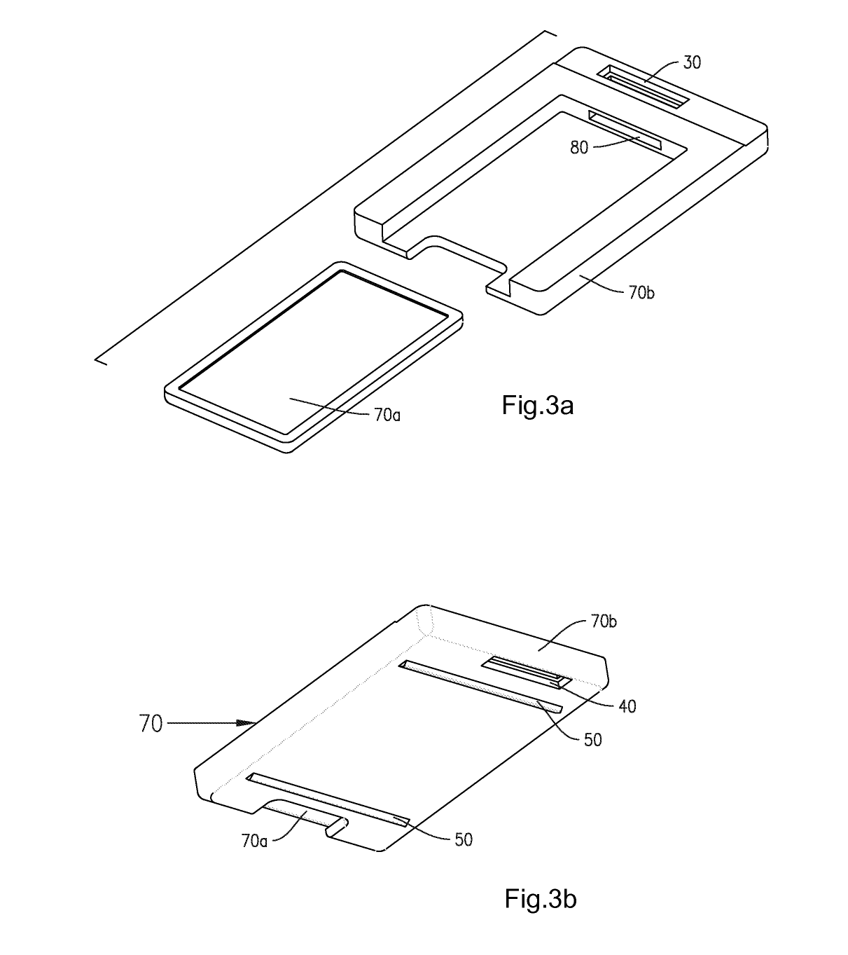

FIG. 3a and FIG. 3b present a scalable embodiment of a tablet PC. Tablet PC module 70 comprises a tablet computer, 70a and a cluster adapter 70b. Cluster adapter 70b comprises a top interconnection port 30 and a bottom interconnection port 40, identical to the same-numbered ports in FIG. 1 and FIG. 2.

The adapter further comprises a tablet PC port 80, connecting cluster adapter 70b to the tablet computer. Tablet computer 70a can be slidably attached to the adapter, forming a temporary functional module. Cluster adapter 70b may further comprise a plurality of spacer means 50, rigidly mounted on the underside of said extended cluster adapter.

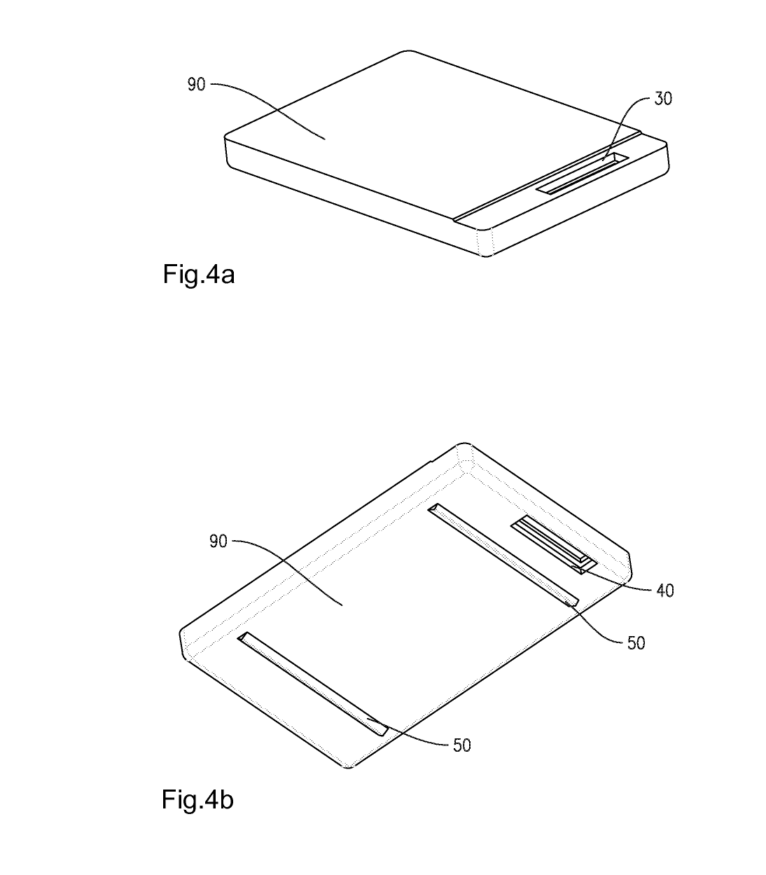

FIG. 4a and FIG. 4b introduce an optional memory expansion unit. A memory module 90 stores a predetermined number of Random-Access Memory (RAM) blocks, of a total capacity substantially larger than normally encountered in a personal computer. Memory module 90 comprises a top interconnection port 30 and a bottom interconnection port 40, identical to the corresponding ports in the portable computers described in FIG. 1, FIG. 2 and FIG. 3.

Memory module 90 may further comprise a plurality of spacer means 50, rigidly mounted on the underside of said extended memory housing.

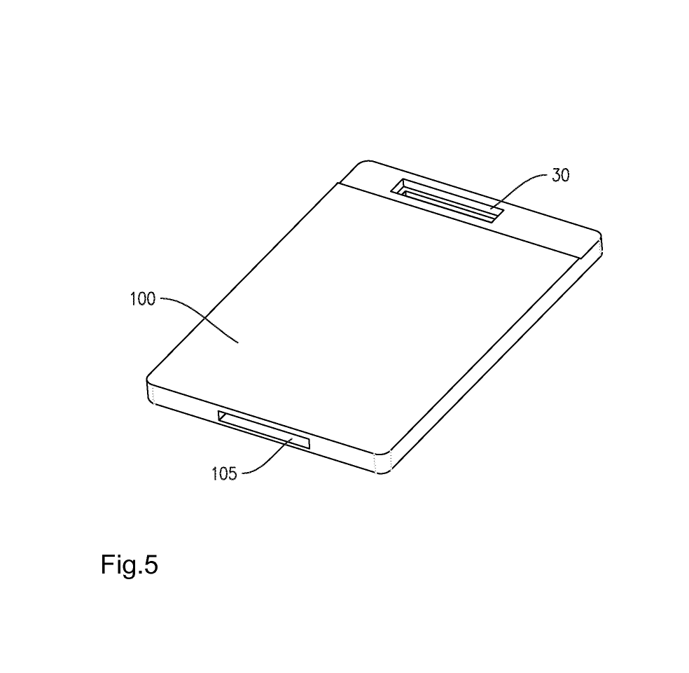

FIG. 5 presents an optional base module 100, comprising a side interconnection port 105 and a top interconnection port 30, said top interconnection port being identical to the corresponding port in the above-described devices. The role of this base module will be clearly explained in the Operation section.

### OPERATION

Building a high-performance computer cluster includes connecting a plurality of the novel portable computers together, using the novel interconnectivity bus.

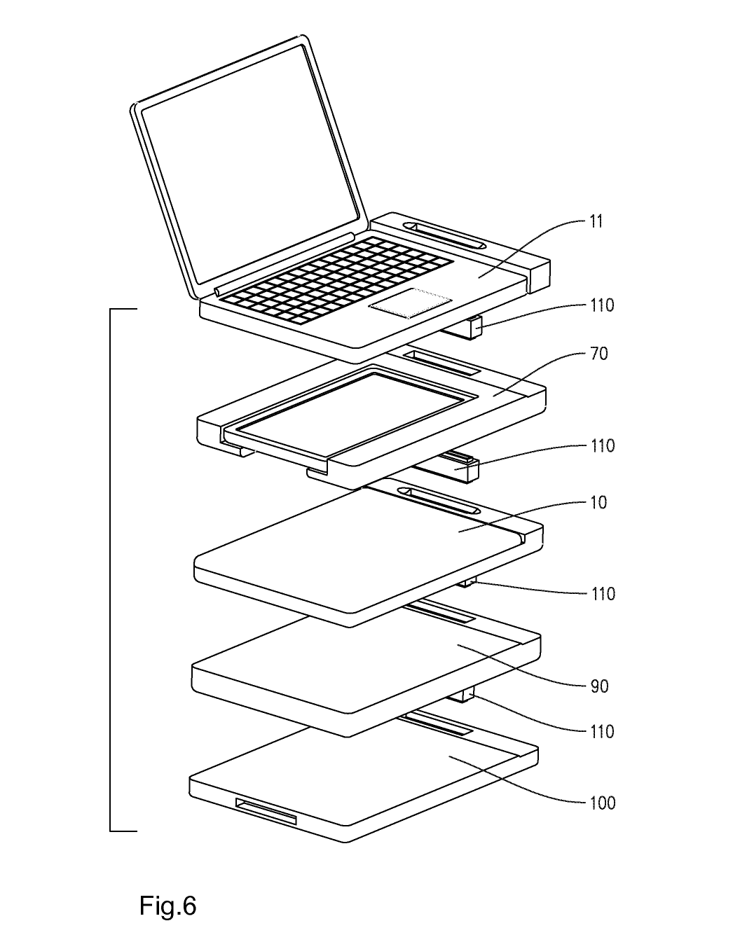

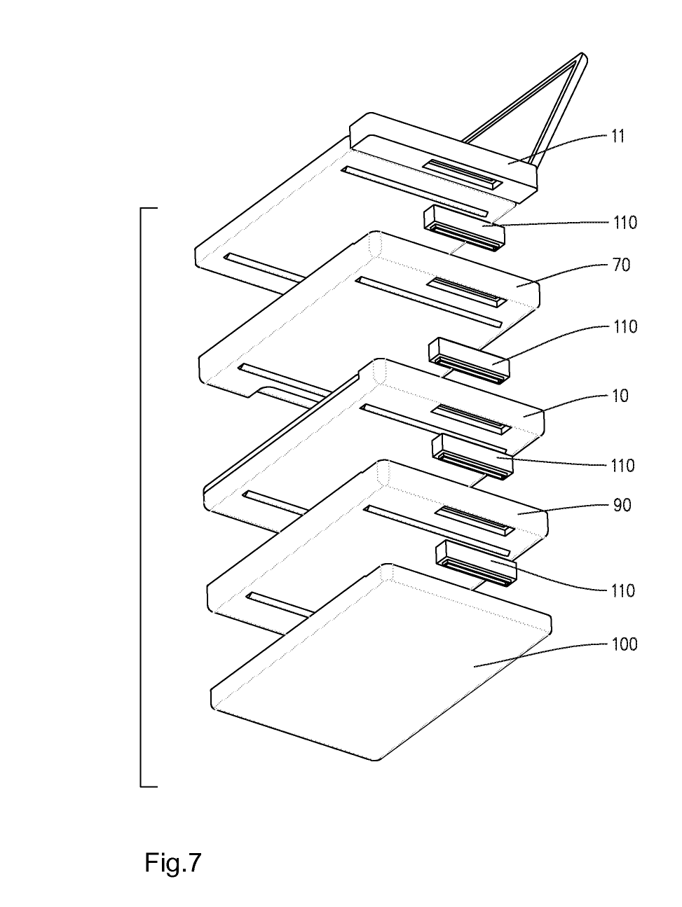

The arrangement depicted by FIG. 6 and FIG. 7 shows a possible cluster configuration, including a base module 100, a memory module 90, an integrated-expansion portable PC 10, a tablet PC module 70 and a scalable mobile PC 11. Each pair of adjacent modules interconnects by means of an interconnection adapter, 110, identical for all connections between all modules.

All of the modules presented in FIG. 1 through FIG. 5 have substantially equal width and length, and the interconnection ports are identically located. Interconnection adapter 110 electrically connects the top interconnection port of a machine to the bottom interconnection port of the next machine up, in the cluster.

The top machine in the stack is usually the master node, serving as user input interface, for the entire cluster. In the preferred architecture, the cluster connectivity bus can transmit a wake signal, from the master node, to the rest of the machines in a cluster. In operation, the cluster connectivity bus accesses the CPU, GPU and memory resources of all the machines, to be optimally utilized according to a predetermined set of instructions.

Additional memory modules may be added, as required by the complexity of the task in process. A memory module may be the most expensive piece of hardware in the cluster, but it does not have to be present for the cluster to operate, so that memory blocks could be borrowed, or leased, as needed.

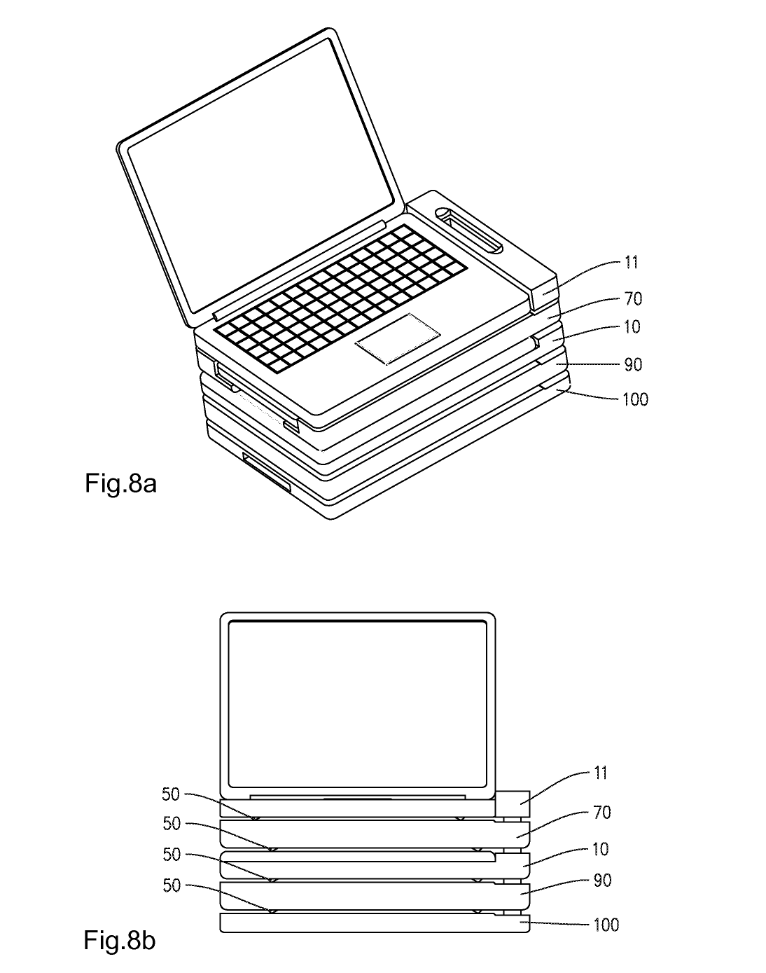

FIG. 8a is a normal, non-exploded view of the cluster of FIG. 6 and 7. FIG. 8b is a frontal view of the same cluster. Spacer means 50, present on each module, create air gaps between adjacent units, thereby effectively providing an airflow path, for cooling the cluster component modules.

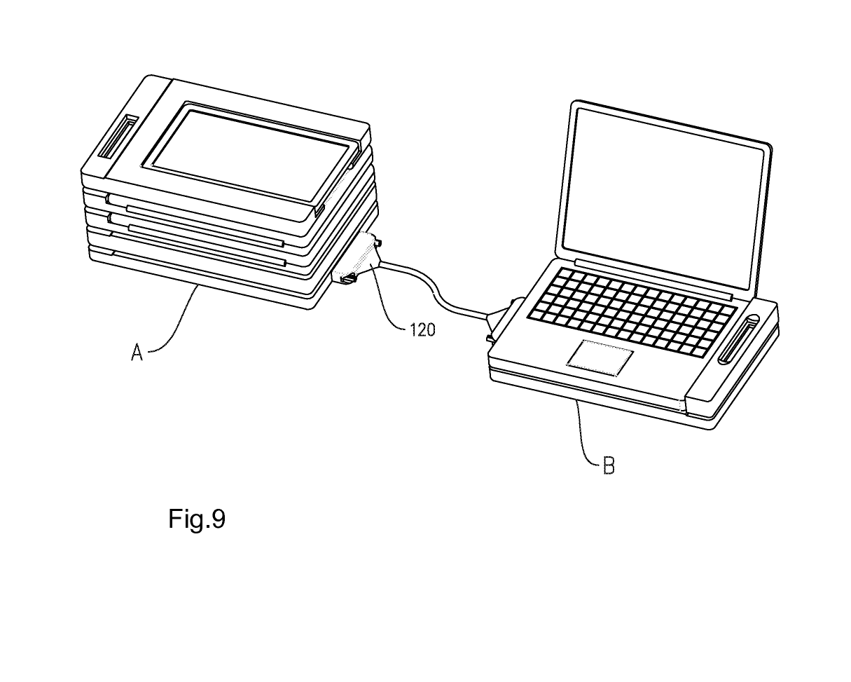

The optional base module can be used either to link two cluster stacks together, or to connect a stack to an additional computer/base module pack. In the example form FIG. 9, a connection cable 120 plugs into the side interconnection port of two base modules, thereby connecting a cluster stack A to a separate master computer B. This way, the master node can be advantageously placed for easy user access.

### CONCLUSION, RAMIFICATIONS AND SCOPE

Thus the reader will see that the portable-computer system of the invention provides a simple yet effective solution for building an on-demand high-performance computer cluster, utilizing a set of general-use machines.

Accordingly, the scope of the invention should be determined not by the embodiments illustrated, but by the appended claims and their legal equivalents.

I claim:

1. A scalable computer system, comprising:
(a) A plurality of portable node computers, preferably embodied by a notebook computer, wherein each portable node computer comprises:
(b) a base surface, upon which the computer is supported during normal operation, and
(c) a connectivity bus, electrically communicating with the central processing unit of the computer and wherein said connectivity bus is preferably further connected with the graphics processing units of the node computer, and
(d) a stack connector, electrically connected to said connectivity bus, and comprising at least a pair of connection interfaces, oriented in mutually opposite directions, along a plane substantially perpendicular to said base surface,
(e) whereby connecting said stack connectors of distinct node computers affords stacking a plurality of node computers, in a columnar arrangement, each computer being electrically connected to the central processing unit and to the graphics processing units of the remainder of node computers within said columnar arrangement.

2. The scalable computer system of claim 1, further comprising:
(a) a memory node, comprising a plurality of random-access memory modules, housed in an enclosure of physical dimensions substantially similar to the dimensions of the computer nodes and
(b) said memory node further comprising a memory stack connector, connectable to said stack connectors of claim 1.

3. The scalable computer system of claim 1, wherein one of said plurality of node computers assumes a master role, providing a human operator interface and managing the computing tasks of the central and graphics processing units of the remainder node computers.

4. A stack adapter means, comprising an enclosure of predetermined dimensions, an adapter stack connector and a device stack connector, effectively providing the means for integrating a computer node of different form factor, selected from the group consisting of notebook computers, tablet computers and hand-held computers.
